(19) United States
(12) Patent Application Publication
(10) Pub. No.: US 2025/0371680 A1
(43) Pub. Date: Dec. 4, 2025

(54) IMAGE FRAME DENOISING USING A DELTA FRAME

(71) Applicant: QUALCOMM Incorporated, San Diego, CA (US)

(72) Inventors: Hyung Cook Kim, San Diego, CA (US); Xiaoyun Jiang, San Diego, CA (US); Yunqiang Chen, San Diego, CA (US)

(21) Appl. No.: 18/732,908

(22) Filed: Jun. 4, 2024

(51) Int. Cl. G06T 5/70; G06T 5/50; G06T 19/00

(52) U.S. Cl. CPC G06T 5/70; G06T 5/50; G06T 19/006; G06T 2207/10016; G06T 2207/20182

(57) ABSTRACT

In some aspects, an apparatus includes a processing system including one or more memories and one or more processors coupled to the one or more memories. The processing system is configured to obtain an image frame, to obtain a first delta frame corresponding to a difference between the image frame and a reference frame, and to perform a denoising operation associated with the first delta frame to generate a second delta frame. The processing system is further configured to obtain an output image frame corresponding to a sum of the second delta frame and the reference frame and to perform one or more operations using the output image frame.

### TECHNICAL FIELD

Aspects relate generally to image processing, and more particularly, to denoising of images.

### INTRODUCTION

Image capture devices may be used to capture one or more digital images, such as still images for photos or sequences of images for videos. Image capture devices may be incorporated into a wide variety of devices. For example, image capture devices may be implemented as stand-alone digital cameras, digital video camcorders, camera-equipped wireless communication device handsets (such as cellular telephones or satellite telephones), personal digital assistants (PDAs), tablets, gaming devices, computing devices, webcams, video surveillance cameras, wearable devices, or other devices with digital imaging or video capabilities.

In some cases, images captured by image capture devices may include noise that may detract from image quality of the images. To improve image quality of captured images, some image capture devices may use denoising. For example, denoising techniques may include spatial denoising, temporal denoising, and spatial-temporal denoising.

Some denoising techniques may be difficult or infeasible to implement in some types of image capture devices. To illustrate, frames of video captured by a wearable device may be misaligned due to movement of the wearable device and may use a high frame rate associated with a relatively large amount of noise (e.g., due to a relatively short exposure time). Further, such misaligned frames may be difficult to denoise. Some image capture devices may attempt to identify “matching” frames that are similar to one another and may selectively denoise the matching frames. Searching for such matching frames may consume processing cycles, processing resources, and power. Additionally, some image capture devices (such as a wearable device) may be relatively sensitive to power consumption and latency associated with denoising. Further, in the case of a fast-moving image capture device, the image capture device may be unable to identify matching frames, in which case the image capture device may be unable to perform denoising of the frames.

### BRIEF SUMMARY OF SOME EXAMPLES

The systems, methods and devices of this disclosure each have several innovative aspects, no single one of which is solely responsible for the desirable attributes disclosed herein.

In some aspects, an apparatus includes a processing system including one or more memories and one or more processors coupled to the one or more memories. The processing system is configured to obtain an image frame, to obtain a first delta frame corresponding to a difference between the image frame and a reference frame, and to perform a denoising operation associated with the first delta frame to generate a second delta frame. The processing system is further configured to obtain an output image frame corresponding to a sum of the second delta frame and the reference frame and to perform one or more operations using the output image frame.

In some other aspects, a method includes obtaining an image frame, obtaining a first delta frame corresponding to a difference between the image frame and a reference frame, and performing a denoising operation associated with the first delta frame to generate a second delta frame. The method further includes obtaining an output image frame corresponding to a sum of the second delta frame and the reference frame and performing one or more operations using the output image frame.

In some additional aspects, a non-transitory computer-readable medium stores instructions executable by one or more processors to initiate, perform, or control operations. The operations include obtaining an image frame, obtaining a first delta frame corresponding to a difference between the image frame and a reference frame, and performing a denoising operation associated with the first delta frame to generate a second delta frame. The operations further include obtaining an output image frame corresponding to a sum of the second delta frame and the reference frame and performing one or more operations using the output image frame.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a block diagram of an example device for performing image capture from one or more image sensors.

FIG. 2 is a block diagram illustrating an example system for image data processing in an image capture device.

FIG. 3 is a block diagram illustrating an example of a delta frame denoising engine.

FIG. 4 is a diagram of an example wearable device that may include a delta frame denoising engine.

FIG. 5 is a flow chart of an example method for processing image data.

Like reference numbers and designations in the various drawings indicate like elements.

### DETAILED DESCRIPTION

To denoise an image frame, an image capture device may generate a delta frame based on a difference between the image frame and a reference frame. The image capture device may denoise the delta frame to generate a denoised frame and may add the reference frame to the denoised frame to generate an output image frame. The output image frame may have a reduced amount of temporal noise as compared to the image frame. Generating the output image frame using the delta frame (and adding the reference frame to the denoised frame) may be referred to as indirectly denoising the image frame. In some examples, the reference frame may correspond to a blended version of multiple frames preceding the image frame in a sequence of images captured by a camera.

By indirectly denoising the image frame using the delta frame, temporal performance may be improved as compared to some denoising techniques. To illustrate, because the reference frame may be a blended version of multiple frames, the reference frame may have a relatively low temporal noise variance. As a result, by adding the denoised delta frame to the reference frame, the output image frame may also have a relatively low temporal noise variance, which may improve temporal performance of the denoising as compared to directly denoising the image frame. Further, some denoising techniques may attempt to identify “matching” frames that are similar to one another and may selectively denoise the matching frames, which may consume processing cycles, processing resources, and power. By indirectly denoising image frames, denoising may be performed irrespective of the magnitude of the difference between the frames, which may increase the quantity of frames that are denoised. Further, because denoising may be performed irrespective of the magnitude of the difference between the frames, the image capture device may avoid searching for matching frames (and may therefore avoid using processing cycles, processing resources, and power associated with searching for matching frames).

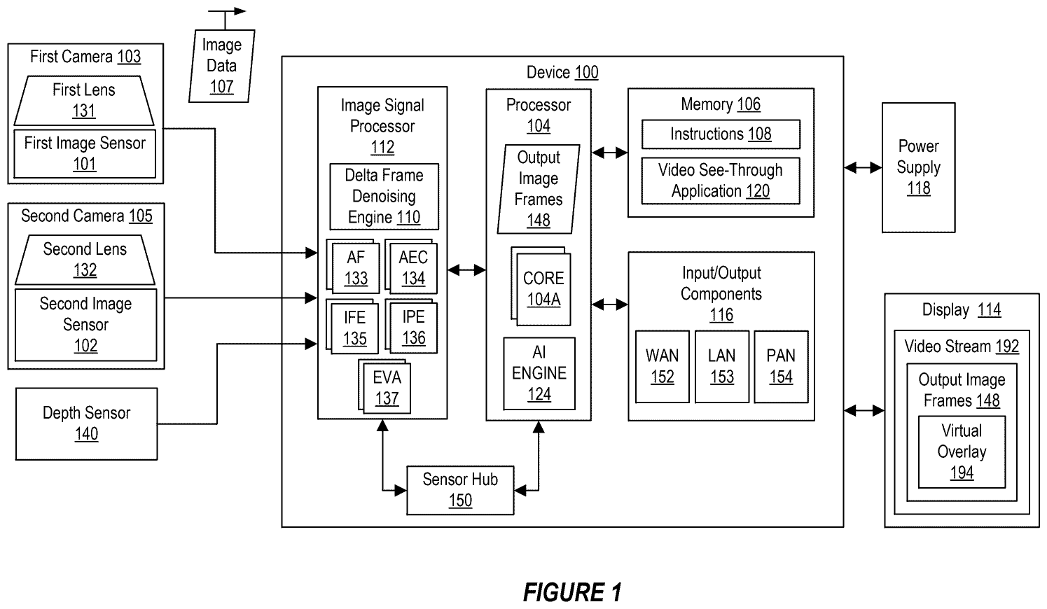

FIG. 1 is a block diagram of a device 100 for performing image capture from one or more image sensors. The device 100 may include, or be coupled to, an image signal processor (ISP) 112 for processing image frames from one or more image sensors, such as a first image sensor 101, a second image sensor 102, and a depth sensor 140. In some implementations, the device 100 also includes or is coupled to a processor 104 and a memory 106 storing instructions 108 (e.g., a memory storing processor-readable code or a non-transitory computer-readable medium storing instructions). The device 100 may also include or be coupled to a display 114 and components 116. Components 116 may be used for interacting with a user. For example components 116 may include a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one embodiment, a local bus connection couples the ISP 112 to the first image sensor 101 and second image sensor 102 of a first camera 103 and second camera 105, respectively. In another embodiment, a wire interface couples the ISP 112 to an external image sensor. In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data. The digital image data may be formatted as one or more image frames, whether received from the first camera 103 and/or second camera 105 or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different fields of view (FOVs) to capture different representations of a scene. For example, the first lens 131 may be an ultra-wide (UW) lens and the second lens 132 may be a wide (W) lens. The multiple image sensors may include a combination of UW, W, tele (T), and ultra-tele (UT) sensors.

Each of the first camera 103 and second camera 105 may be configured through hardware configuration and/or software settings to obtain different, but overlapping, FOVs. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A VA camera may have different characteristics that produced different representations of a scene based on a current aperture size. For example, a VA camera may capture image data with a depth of focus (DOF) corresponding to a current aperture size set for the VA camera.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mm Wave, radio detection and ranging (Radar), and/or hybrid depth sensors, such as structured light sensors. In embodiments without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include hardware (such as one or more integrated circuits (ICs)) configured to perform one or more operations described in the present disclosure. To illustrate, the ISP 112 may include a delta frame denoising engine 110 that may initiate, perform, or control one or more operations described herein. Depending on the implementation, the delta frame denoising engine 110 may be implemented using instructions executable by the ISP 112, hardware, or a combination thereof.

FIG. 1 also illustrates that the ISP 112 may include image front ends (e.g., IFE 135), image post-processing engines (e.g., IPE 136), auto exposure compensation (AEC) engines (e.g., AEC 134), and/or one or more engines for video analytics (e.g., EVA 137). An image pipeline may be formed by a sequence of one or more of the IFE 135, IPE 136, and/or EVA 137. In some embodiments, the image pipeline may be reconfigurable in the ISP 112 by changing connections between the IFE 135, IPE 136, and/or EVA 137. The AF 133, AEC 134, IFE 135, IPE 136, and EVA 137 may each include application-specific circuitry, be embodied as software or firmware executed by the ISP 112, and/or a combination of hardware and software or firmware executing on the ISP 112.

The memory 106 may include a non-transient or non-transitory computer readable medium storing computer-executable instructions as instructions 108 to perform all or a portion of one or more operations described herein. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or second camera 105 and the ISP 112.

In addition to instructions 108, the memory 106 may also store image frames. The image frames may be output image frames stored by the ISP 112. The output image frames may be accessed by the processor 104 for further operations. In some embodiments, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some embodiments, the device 100 is a system-on-chip (SoC) that incorporates the ISP 112, the processor 104, the sensor hub 150, the memory 106, and/or components 116 into a single package.

In some embodiments, the processor 104 may include one or more processor cores 104A-N capable of executing instructions to control operation of the ISP 112. For example, the cores 104A-N may execute a camera application (or another application for generating images or video) stored in the memory 106 to activate or deactivate the ISP 112 for capturing image frames and/or to control delta frame denoising performed by the delta frame denoising engine 110.

In some embodiments, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, face detection and/or object recognition performed using machine learning (ML) or artificial intelligence (AI). The AI engine 124 may be referred to as an Artificial Intelligence Processing Unit (AIPU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training. In some other embodiments, the device 100 may not include the processor 104, such as when all of the described functionality is configured in the ISP 112.

In some embodiments, the display 114 may include one or more displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

During operation, the ISP 112 may receive image data 107 from one or more of the first camera 103 or the second camera 105. In some examples, the image data 107 may include depth data generated by the depth sensor 140. The ISP 112 may perform denoising of the image data 107 using the delta frame denoising engine 110 to generate output image frames 148. In some implementations, the ISP 112 may provide the output image frames 148 to the processor 104. In some other implementations, the ISP 112 may perform one or more other operations using the output image frames 148, such as by storing the output image frames 148 to the memory 106, sending the output image frames to another device (e.g., via the components 116), or performing one or more other operations.

In some examples, the processor 104 may execute a video see-through application 120 and may present extended reality (XR) content via the display 114 based on the output image frames 148. To illustrate, the display 114 may present a video stream 192 that includes the output image frames 148. The processor 104 may execute the video see-through application 120 to add XR content to the video stream 192, such as a virtual overlay 194 to one or more of the output image frames 148.

In some implementations, at least one of the ISP 112 or the processor 104 executes instructions to perform one or more operations described herein, such as delta frame denoising. For example, execution of the instructions may cause the ISP 112 to begin or end capturing an image frame or a sequence of image frames using one or more cameras, such as the first camera 103, the second camera 105, or both. The image data 107 may include the image frame or sequence of image frames. Further, execution of the instructions may cause the ISP 112 to perform delta frame denoising of the image frame or sequence of image frames using the delta frame denoising engine 110 to generate an output image frame of the output image frames 148. In addition, execution of the instructions may cause the ISP 112 to perform one or more operations based on the output image frame. In some examples, the one or more operations may include storing the output image frame to the memory 106, presenting the output image frame via the display 114, transmitting the output image frame to another device via the components 116, providing the output image frame to the processor 104, performing one or more other operations, or a combination thereof.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. Additionally, other components, numbers of components, or combinations of components may be included in a device for performing aspects of the present disclosure. As such, the present disclosure is not limited to a specific device or configuration of components, including the device 100.

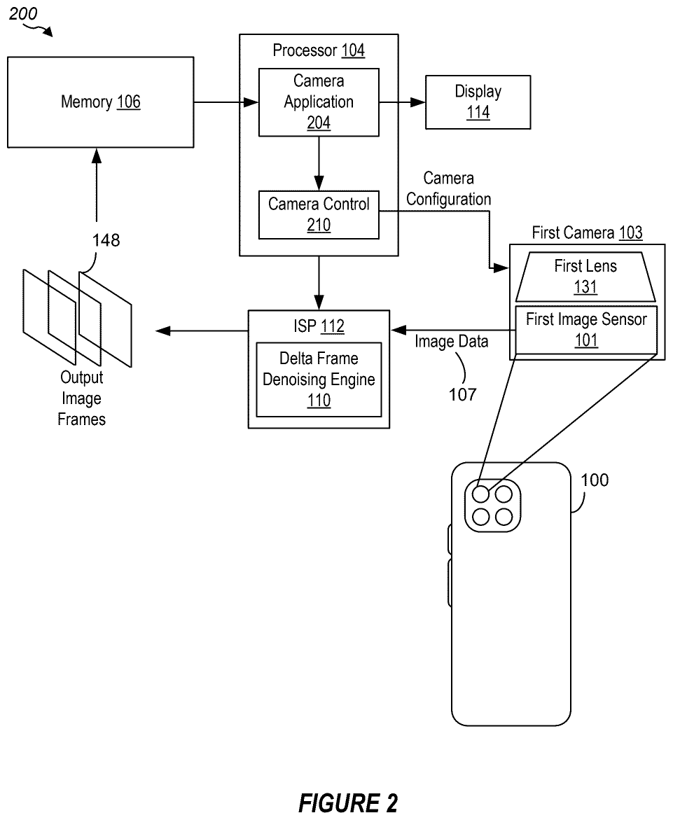

FIG. 2 is a block diagram illustrating an example system 200 for image data processing in an image capture device. Although FIG. 2 may depict an implementation of the device 100 as a mobile device (such as a smart phone) for illustration, in some other examples, one or more features of the disclosure may be used with another type of device. To illustrate, in some other examples, the device 100 may be implemented as or included in a wearable device, such as a smart watch or a headset.

Processor 104 of system 200 may communicate with ISP 112 through a bi-directional bus and/or separate control and data lines. The processor 104 may control the first camera 103 through camera control 210. The camera control 210 may be a camera driver executed by the processor 104 for configuring the first camera 103, such as to active or deactivate image capture, configure exposure settings, and/or configure aperture size. Camera control 210 may be managed by a camera application 204 executing on the processor 104. The camera application 204 provides settings accessible to a user such that a user can specify individual camera settings or select a profile with corresponding camera settings. Camera control 210 communicates with the first camera 103 to configure the first camera 103 in accordance with commands received from the camera application 204. The camera application 204 may be, for example, a photography application, a document scanning application, a messaging application, or other application that processes image data.

The camera configuration may include parameters that specify, for example, a frame rate, an image resolution, a readout duration, an exposure level, an aspect ratio, an aperture size, etc. The first camera 103 may apply the camera configuration and obtain image data 107 representing a scene using the camera configuration. In some embodiments, the camera configuration may be adjusted to obtain different representations of the scene. For example, the processor 104 may execute a camera application 204 to instruct the first camera 103, through camera control 210, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration. The first image data and the second image data may be included in the image data 107.

In some embodiments in which the first camera 103 is a variable aperture (VA) camera system, the processor 104 may execute a camera application 204 to instruct the first camera 103 to configure to a first aperture size, obtain the first image data from the first camera 103, instruct the first camera 103 to configure to a second aperture size, and obtain the second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 corresponds to a larger aperture size than f/8.0.

The image data 107 received from the first camera 103 may be processed in one or more blocks of the ISP 112 to determine output image frames 148 that may be stored in memory 106 and/or otherwise provided to the processor 104. The processor 104 may further process the image data 107 to apply effects to the output image frames 148. Effects may include Bokeh, lighting, color casting, and/or high dynamic range (HDR) merging. In some embodiments, the effects may be applied in the ISP 112.

The output image frames 148 by the ISP 112 may include representations of the scene improved by aspects of this disclosure, such using delta frame denoising. The processor 104 may display these output image frames 148 to a user, and the improvements provided by the described processing implemented in the ISP 112 and/or processor 104 may improve image quality and user experience. For example, the delta frame denoising engine 110 in the ISP 112 may correct at least some of the image data 107 received from the first camera 103 using delta frame denoising when determining the output image frames 148.

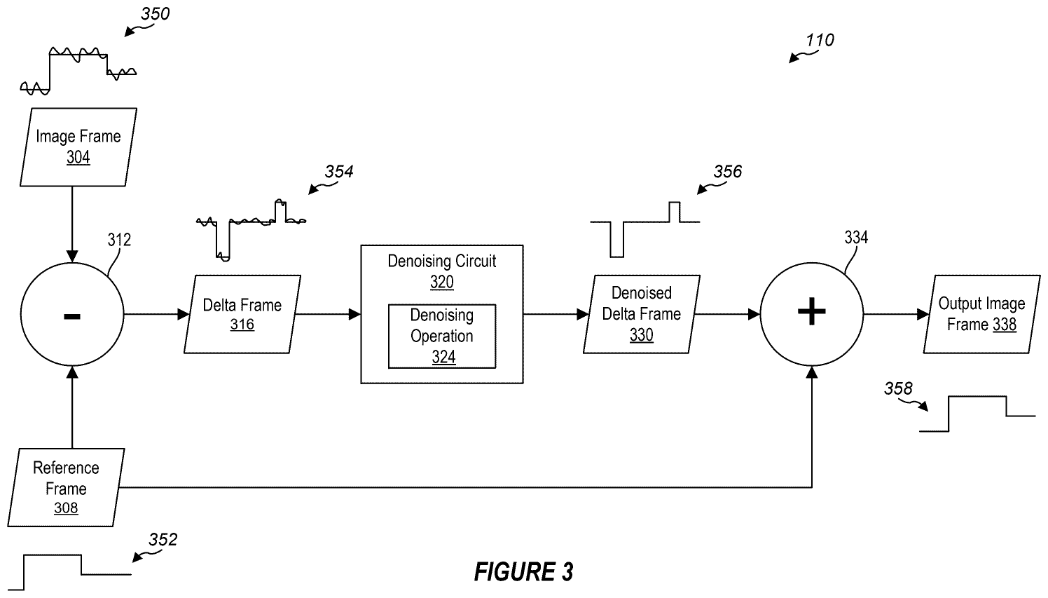

FIG. 3 is a block diagram illustrating an example of the delta frame denoising engine 110. The delta frame denoising engine 110 may include a subtraction circuit 312, a denoising circuit 320, and a summation circuit 334. An output of the subtraction circuit 312 may be coupled to an input of the denoising circuit 320. An output of the denoising circuit 320 may be coupled to an input of the summation circuit 334.

During operation, the delta frame denoising engine 110 may obtain an image frame 304. For example, the delta frame denoising engine 110 may receive the image frame 304 from the first camera 103 or from the second camera 105 of FIG. 1. In some examples, the image frame 304 may be included in the image data 107 of FIG. 2.

The delta frame denoising engine 110 may also obtain a reference frame 308. In some examples, the image frame 304 and the reference frame 308 may be included in a sequence of image frames captured by a camera (such as the first camera 103 or the second camera 105), and the reference frame 308 may precede the image frame 304 in the sequence of image frames. To illustrate, the image frame 304 may correspond to the Nth image frame in the sequence of image frames, and the reference frame 308 may correspond to the (N−1)th image frame in the sequence, the (N−2)th image frame in the sequence, or the (N−M)th image frame in the sequence, where N indicates a positive integer, and where M indicates a positive integer that is less than N.

In another example, the reference frame 308 may be based on multiple frames of the sequence of image frames. For example, the reference frame 308 may correspond to a blended image frame that is based on multiple preceding frames that precede the image frame 304 in the sequence of image frames. To further illustrate, the reference frame 308 may correspond to a blend of the K image frames that preceded the image frame 304 in the sequence (e.g., a blend of N−1, N−2, . . . N−K, where K indicates a positive integer). In some such examples, the ISP 112 may select, for each image frame of the sequence following the Kth image frame, the K preceding images frames for a blending process, which may include generating the reference frame 308.

The delta frame denoising engine 110 may determine a difference between the image frame 304 and the reference frame 308 to determine a first delta frame, such as a delta frame 316. For example, the delta frame denoising engine 110 may subtract the reference frame 308 from the image frame 304 to generate the delta frame 316. The delta frame 316 may correspond to or may indicate a difference (or delta) between the image frame 304 and the reference frame 308. In some examples, the subtraction circuit 312 may obtain the delta frame 316 by performing a pixel-by-pixel subtraction of reference pixels of the reference frame 308 from pixels of the image frame 304.

The delta frame denoising engine 110 may input the delta frame 316 to the denoising circuit 320. The denoising circuit 320 may perform a denoising operation 324 based on the delta frame 316 to generate a second delta frame, such as a denoised delta frame 330. For example, the denoising operation 324 may include spatial denoising of the delta frame 316, temporal denoising of multiple image frames including the delta frame 316, spatial-temporal video denoising of multiple image frames including the delta frame 316, low-pass filtering of the delta frame 316, one or more other processing operations, or a combination thereof.

The delta frame denoising engine 110 may input the denoised delta frame 330 to the summation circuit 334. The summation circuit 334 may sum the denoised delta frame 330 with the reference frame 308 to generate an output image frame 338. In some examples, the output image frame 338 may be included in the output image frames 148 of FIGS. 1 and 2. In some examples, the summation circuit 334 may obtain the output image frame 338 by performing a pixel-by-pixel addition operation of reference pixels of the reference frame 308 to pixels of the denoised delta frame 330.

In some examples, the device 100 of FIG. 1 may perform one or more operations based on the output image frame 338. To illustrate, in some examples, execution of the video see-through application 120 may specify that the output image frame 338 is to be augmented with XR content. The device 100 may initiate display of video content at the display 114, and the video content may include the output image frame 338 and the virtual overlay 194 of the output image frame 338. In some examples, the image frame 304 may include a first amount of temporal noise, and the output image frame 338 may include a second amount of temporal noise that is less than the first amount of temporal noise.

To further illustrate, FIG. 3 illustrates that the image frame 304 may be associated with a waveform 350 having a first amount of noise. The reference frame 308 may be associated with a second waveform 352 having a second amount of noise. In some examples, the second amount of noise may be less than the first amount of noise. In some examples, the second amount of noise may be relatively small, as illustrated in the example of FIG. 3. To illustrate, in some implementations, a blending process used to generate the reference frame 308 may result in a relatively small noise variance of the reference frame 308 as compared to the image frame 304. For example, if the reference frame 308 is generated by blending K image frames each having a noise variance of V, the reference frame 308 may have a noise variance of VIK.

FIG. 3 also illustrates that the delta frame 316 may be associated with a waveform 354 having a third amount of noise, and the denoised delta frame 330 may be associated with a waveform 356 having a fourth amount of noise. In some examples, the third amount of noise may be less than the first amount of noise. In some examples, the fourth amount of noise may be less than the first amount of noise and the third amount of noise. Further, the output image frame 338 may be associated with a waveform 358 having a fifth amount of noise. In some examples, the fifth amount of noise may be less than the first amount of noise and the third amount of noise.

In some examples, operation of the delta frame denoising engine 110 may be referred to as content insensitive denoising. To illustrate, some convention denoising techniques may directly denoise an image frame only if a difference between the image frame and another image frame (e.g., a previous image frame) is within a threshold associated with directly denoising image frames. In some examples, by subtracting the reference frame 308 from the image frame 304 prior to performing the denoising operation 324 (and by subsequently adding the reference frame 308 to the denoised delta frame 330), the denoising operation 324 may be performed irrespective of a magnitude of the difference between the image frame 304 and the reference frame 308. Further, the denoising operation 324 may be performed even if the magnitude of the difference between the image frame 304 and the reference frame 308 exceeds the threshold associated with directly denoising image frames.

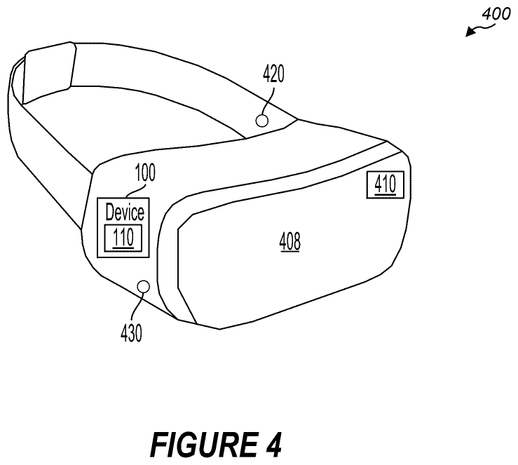

FIG. 4 is a diagram of an example wearable device 400 that may include the delta frame denoising engine 110. In some examples, the wearable device 400 may correspond to an extended reality (XR) headset, a virtual reality (VR) headset, a mixed reality headset, or an augmented reality headset. The wearable device 400 may include a display 408, a camera 410, one or more speakers 420, one or more microphones 430. Additionally, the wearable device 400 may include the device 100 including the delta frame denoising engine 110. In some examples, the camera 410 may include or correspond to one or more of the first camera 103 or the second camera 105.

During operation, the delta frame denoising engine 110 may perform delta frame denoising of one or more images, such as a sequence of images captured by the camera 410. For example, the device 100 may execute the video see-through application 120 and may capture the sequence of images in accordance with execution of the video see-through application 120. The device 100 may use the delta frame denoising engine 110 to denoise the sequence of images and may use the display 408 to present video content (e.g., the video stream 192) based on the denoised sequence of images.

By indirectly denoising the image frame 304 using the delta frame 316, performance may be improved as compared to some denoising techniques. To illustrate, because the reference frame 308 may be a blended version of multiple frames, the reference frame 308 may have a relatively low temporal noise variance. As a result, by adding the denoised delta frame 330 to the reference frame 308, the output image frame 338 may also have a relatively low temporal noise variance, which may improve performance of the denoising operation 324 as compared to directly denoising the image frame 304. Further, some denoising techniques may attempt to identify “matching” frames that are similar to one another and may selectively denoise the matching frames, which may consume processing cycles, processing resources, and power. By indirectly denoising image frames, denoising may be performed irrespective of the magnitude of the difference between the frames, which may increase the quantity of frames that are denoised. Further, because the denoising operation 324 may be performed irrespective of the magnitude of the difference between frames, the device 100 may avoid searching for matching frames (and may therefore avoid using processing cycles, processing resources, and power associated with searching for matching frames).

To further illustrate, in some implementations, temporal denoising may operate on a delta image between a current frame and a reference frame. Even if mismatches exist between the current frame and the reference frame, such mismatches may not influence the denoising. Matching regions between the frames may have delta values of zero, and non-matching regions may have delta values as non-zero. Denoising may have similar performance on both types of regions. After denoising the delta frame, the noise difference between the current frame and the reference frame may be reduced (e.g., so that temporal noise is reduced). The cleaned delta frame may be back to the reference frame to generate an output frame having the same (or similar) contents as the current frame but with reduced temporal noise.

Such temporal denoising may be performed event in the presence of mismatching image frame contents. Accordingly, the temporal denoising may be particularly suitable for applications with a great degree of motion or applications in which matching with a reference frame is difficult. Other techniques (e.g., denoising based on content matching) may be infeasible in such applications due to misalignment between a current frame and a reference frame, which may occur due to a high frame rate and fast motion that may be associated with a headset, for example. In some aspects, temporal denoising may be performed based on the delta frame instead of the input frame, so that denoising is not sensitive to content alignment. The denoising may include reducing the difference between the input frame and the reference frame to reduce or avoid noise flickering between the frames to achieve temporal denoising. In some implementations, the denoising may be used in connection with a video see-through application to avoid the influence from motion between frames. Further, the denoising may be used in connection with inline processing, which may be associated with a lower image alignment requirement (which may involve offline processing, and which therefore may increase latency).

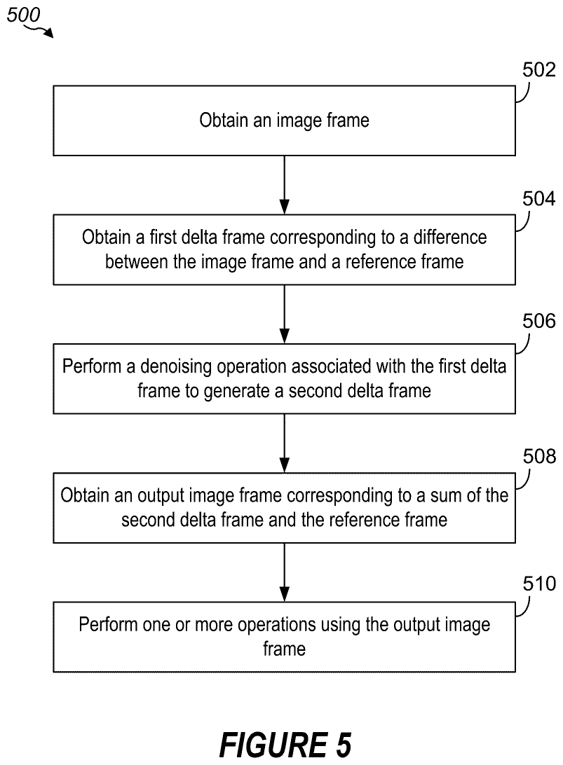

FIG. 5 is a flow chart of an example method 500 for processing image data. In some examples, the method 500 may be performed by one or more devices described herein. For example, the method 500 may be performed by one or more of the device 100, the delta frame denoising engine 110, the ISP 112, the system 200, the wearable device 400, one or more other devices, or a combination thereof.

The method 500 includes obtaining an image frame, at 502. For example, the delta frame denoising engine 110 may obtain the image frame 304.

The method 500 further includes obtaining a first delta frame corresponding to a difference between the image frame and a reference frame, at 504. For example, the delta frame denoising engine 110 may obtain the delta frame 316. The delta frame 316 may correspond to a difference between the image frame 304 and the reference frame 308.

The method 500 further includes performing a denoising operation associated with the first delta frame to generate a second delta frame, at 506. For example, the delta frame denoising engine 110 may perform the denoising operation 324 associated with the delta frame 316 to generate the denoised delta frame 330.

The method 500 further includes obtaining an output image frame corresponding to a sum of the second delta frame and the reference frame, at 508. For example, the delta frame denoising engine 110 may determine the output image frame 338 corresponding to a sum of the denoised delta frame 330 and the reference frame 308.

The method 500 further includes performing one or more operations using the output image frame, at 510. To illustrate, in some example, the delta frame denoising engine 110 may perform one or more operations using the output image frame 338, such as by outputting the output image frame 338 to one or more other components (e.g., to the processor 104, to the memory 106, or to one or more of the components 116, as illustrative examples).

In a first aspect, an apparatus includes a processing system including one or more memories and one or more processors coupled to the one or more memories. The processing system is configured to obtain an image frame, to obtain a first delta frame corresponding to a difference between the image frame and a reference frame, and to perform a denoising operation associated with the first delta frame to generate a second delta frame. The processing system is further configured to obtain an output image frame corresponding to a sum of the second delta frame and the reference frame and to perform one or more operations using the output image frame.

In a second aspect, in combination with the first aspect, the reference frame corresponds to one of a preceding frame that precedes the image frame in a sequence of image frames captured by a camera or a blended frame that is based on multiple preceding frames that precede the image frame in the sequence of image frames.

In a third aspect, in combination with one or more of the first aspect or the second aspect, the camera is included in a wearable device, and the sequence of image frames is captured in accordance with execution of an extended reality (XR) application by the wearable device.

In a fourth aspect, in combination with one or more of the first aspect through the third aspect, the processing system is further configured to perform a pixel-by-pixel subtraction of reference pixels of the reference frame from pixels of the image frame.

In a fifth aspect, in combination with one or more of the first aspect through the fourth aspect, the processing system is further configured to perform a pixel-by-pixel addition operation of reference pixels of the reference frame to pixels of the second delta frame.

In a sixth aspect, in combination with one or more of the first aspect through the fifth aspect, the processing system is further configured to perform the denoising operation irrespective of a magnitude of the difference between the image frame and the reference frame.

In a seventh aspect, in combination with one or more of the first aspect through the sixth aspect, a magnitude of the difference between the image frame and the reference frame exceeds a threshold associated with directly denoising image frames.

In an eighth aspect, in combination with one or more of the first aspect through the seventh aspect, the processing system is further configured to execute a video see-through application that specifies that the output image frame is to be augmented with extended reality (XR) content and to initiate display of video content at a display, where the video content includes the output image frame and a virtual overlay of the output image frame.

In a ninth aspect, in combination with one or more of the first aspect through the eighth aspect, the image frame includes a first amount of temporal noise, and the output image frame includes a second amount of temporal noise that is less than the first amount of temporal noise.

In a tenth aspect, a method includes obtaining an image frame, obtaining a first delta frame corresponding to a difference between the image frame and a reference frame, and performing a denoising operation associated with the first delta frame to generate a second delta frame. The method further includes obtaining an output image frame corresponding to a sum of the second delta frame and the reference frame and performing one or more operations using the output image frame.

In an eleventh aspect, in combination with the tenth aspect, the reference frame corresponds to one of a preceding frame that precedes the image frame in a sequence of image frames captured by a camera or a blended frame that is based on multiple preceding frames that precede the image frame in the sequence of image frames.

In a twelfth aspect, in combination with one or more of the tenth aspect through the eleventh aspect, the camera is included in a wearable device, and the sequence of image frames is captured in accordance with execution of an extended reality (XR) application by the wearable device.

In a thirteenth aspect, in combination with one or more of the tenth aspect through the twelfth aspect, obtaining the first delta frame includes performing a pixel-by-pixel subtraction of reference pixels of the reference frame from pixels of the image frame.

In a fourteenth aspect, in combination with one or more of the tenth aspect through the thirteenth aspect, obtaining the output image frame includes performing a pixel-by-pixel addition operation of reference pixels of the reference frame to pixels of the second delta frame.

In a fifteenth aspect, in combination with one or more of the tenth aspect through the fourteenth aspect, the denoising operation is performed irrespective of a magnitude of the difference between the image frame and the reference frame.

In a sixteenth aspect, in combination with one or more of the tenth aspect through the fifteenth aspect, a magnitude of the difference between the image frame and the reference frame exceeds a threshold associated with directly denoising image frames.

In a seventeenth aspect, in combination with one or more of the tenth aspect through the sixteenth aspect, the method further includes executing a video see-through application that specifies that the output image frame is to be augmented with extended reality (XR) content and further includes initiating display of video content at a display, where the video content includes the output image frame and a virtual overlay of the output image frame.

In an eighteenth aspect, in combination with one or more of the tenth aspect through the seventeenth aspect, the image frame includes a first amount of temporal noise, and the output image frame includes a second amount of temporal noise that is less than the first amount of temporal noise.

In a nineteenth aspect, a non-transitory computer-readable medium stores instructions executable by one or more processors to initiate, perform, or control operations. The operations include obtaining an image frame, obtaining a first delta frame corresponding to a difference between the image frame and a reference frame, and performing a denoising operation associated with the first delta frame to generate a second delta frame. The operations further include obtaining an output image frame corresponding to a sum of the second delta frame and the reference frame and performing one or more operations using the output image frame.

In a twentieth aspect, in combination with the nineteenth aspect, the reference frame corresponds to one of a preceding frame that precedes the image frame in a sequence of image frames captured by a camera or a blended frame that is based on multiple preceding frames that precede the image frame in the sequence of image frames.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a−b, a−c, b−c, and a−b−c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus comprising:
a processing system including one or more memories and one or more processors coupled to the one or more memories, the processing system configured to:
obtain an image frame;
obtain a first delta frame corresponding to a difference between the image frame and a reference frame;
perform a denoising operation associated with the first delta frame to generate a second delta frame;
obtain an output image frame corresponding to a sum of the second delta frame and the reference frame; and
perform one or more operations using the output image frame.

2. The apparatus of claim 1, wherein the reference frame corresponds to one of a preceding frame that precedes the image frame in a sequence of image frames captured by a camera or a blended frame that is based on multiple preceding frames that precede the image frame in the sequence of image frames.

3. The apparatus of claim 2, wherein the camera is included in a wearable device, and wherein the sequence of image frames is captured in accordance with execution of an extended reality (XR) application by the wearable device.

4. The apparatus of claim 1, wherein the processing system is further configured to perform a pixel-by-pixel subtraction of reference pixels of the reference frame from pixels of the image frame.

5. The apparatus of claim 1, wherein the processing system is further configured to perform a pixel-by-pixel addition operation of reference pixels of the reference frame to pixels of the second delta frame.

6. The apparatus of claim 1, wherein the processing system is further configured to perform the denoising operation irrespective of a magnitude of the difference between the image frame and the reference frame.

7. The apparatus of claim 1, wherein a magnitude of the difference between the image frame and the reference frame exceeds a threshold associated with directly denoising image frames.

8. The apparatus of claim 1, wherein the processing system is further configured to:
execute a video see-through application that specifies that the output image frame is to be augmented with extended reality (XR) content; and
initiate display of video content at a display, wherein the video content includes the output image frame and a virtual overlay of the output image frame.

9. The apparatus of claim 1, wherein the image frame includes a first amount of temporal noise, and wherein the output image frame includes a second amount of temporal noise that is less than the first amount of temporal noise.

10. A method comprising:
obtaining an image frame;
obtaining a first delta frame corresponding to a difference between the image frame and a reference frame;
performing a denoising operation associated with the first delta frame to generate a second delta frame;
obtaining an output image frame corresponding to a sum of the second delta frame and the reference frame; and
performing one or more operations using the output image frame.

11. The method of claim 10, wherein the reference frame corresponds to one of a preceding frame that precedes the image frame in a sequence of image frames captured by a camera or a blended frame that is based on multiple preceding frames that precede the image frame in the sequence of image frames.

12. The method of claim 11, wherein the camera is included in a wearable device, and wherein the sequence of image frames is captured in accordance with execution of an extended reality (XR) application by the wearable device.

13. The method of claim 10, wherein obtaining the first delta frame includes performing a pixel-by-pixel subtraction of reference pixels of the reference frame from pixels of the image frame.

14. The method of claim 10, wherein obtaining the output image frame includes performing a pixel-by-pixel addition operation of reference pixels of the reference frame to pixels of the second delta frame.

15. The method of claim 10, wherein the denoising operation is performed irrespective of a magnitude of the difference between the image frame and the reference frame.

16. The method of claim 10, wherein a magnitude of the difference between the image frame and the reference frame exceeds a threshold associated with directly denoising image frames.

17. The method of claim 10, further comprising:
executing a video see-through application that specifies that the output image frame is to be augmented with extended reality (XR) content; and
initiating display of video content at a display, wherein the video content includes the output image frame and a virtual overlay of the output image frame.

18. The method of claim 10, wherein the image frame includes a first amount of temporal noise, and wherein the output image frame includes a second amount of temporal noise that is less than the first amount of temporal noise.

19. A non-transitory computer-readable medium storing instructions executable by one or more processors to initiate, perform, or control operations, the operations comprising:
obtaining an image frame;
obtaining a first delta frame corresponding to a difference between the image frame and a reference frame;
performing a denoising operation associated with the first delta frame to generate a second delta frame;
obtaining an output image frame corresponding to a sum of the second delta frame and the reference frame; and
performing one or more operations using the output image frame.

20. The non-transitory computer-readable medium of claim 19, wherein the reference frame corresponds to one of a preceding frame that precedes the image frame in a sequence of image frames captured by a camera or a blended frame that is based on multiple preceding frames that precede the image frame in the sequence of image frames.
